(19) United States
(12) Patent Application Publication
(10) Pub. No.: US 2019/0220164 A1
(43) Pub. Date: Jul. 18, 2019

(54) METHOD AND SYSTEM FOR FACILITATING AN INFINITE NAVIGATION MENU ON A TOUCH SCREEN DEVICE

(71) Applicant: PARKIMON INC., San Francisco, CA (US)

(72) Inventor: Asad Ullah SHAH, Hercules, CA (US)

(21) Appl. No.: 15/873,907

(22) Filed: Jan. 18, 2018

(51) Int. Cl. G06F 3/0488; G06F 3/0484; G06F 3/041; G06F 3/0482

(52) U.S. Cl. CPC G06F 3/0488; G06F 3/04842; G06F 3/0482; G06F 3/0416; G06F 3/0412

(57) ABSTRACT

A user device and a method for facilitating an infinite navigation menu on a touch screen device are disclosed. A current page on a touch screen interface of a user device is displayed. The current page includes one or more expandable items and at least one collapsible item. Each of the one or more expandable items is associated with the at least one collapsible item. A touch input is received at one of an expandable item of the one or more expandable items and a collapsible item of the at least one collapsible item. At least one operation is performed. If the touch input is received at the expandable item, a next set of expandable items associated with the expandable item are displayed and if the touch input is received at the collapsible item, a set of expandable items associated with the collapsible item are hidden from the current page.

### TECHNICAL FIELD

The present disclosure generally relates to user interface (UI) design and, more particularly, to a user device and a method for facilitating an infinite navigation menu on UI such as a touch screen interface of a user device.

### BACKGROUND

Improvements in User Interface (UI) design are typically aimed at enabling a user to conveniently access a function of the user device. Generally, a menu panel or a menu may be provided on the user device for organizing the functions of the user device or an application running on the user device. Clicking a menu simply opens the options under it, which, upon being selected, may perform one or more corresponding functions. For example, Microsoft® Word has a menu called ‘File’ and clicking on ‘File’ lists down the options under it such as ‘New’, ‘Save’ or ‘Print’, which are the specific commands. Although, the menu can provide quick access to several functions of the user device or the applications running on the user device, the number of features/options that may be included in the menu is limited. As more options are added, the menu must get larger or the size of the fonts must get smaller. As the menu can only increase in size to a certain extent depending on the screen size of the user device, the size of the fonts can also only decrease to a certain extent before they become indistinguishable.

Further, adding more options to the menu occupies a greater amount of the display and leaves less display area for displaying the other features of the application, such as a document in a word processor or a graphical image in a graphics application. Also, a menu generally exists at a fixed location on the display resulting in significant cursor movement or a finger movement if the user device includes a touch screen interface. Further, if a user wants to access the menu in existing application utilizing the gesture-enabled menu interface, he/she may use a swipe down gesture to activate the menu. However, this may also simultaneously scroll the page down because the gesture may get recognized as both a scroll command and a menu activation command.

In view of the above, there is a need to provide solutions for enhancing user experience by providing unlimited menu options that do not take up significant amounts of screen space on the user device. There is also a need to interpret the intent of the gesture input provided by the user in the intended way to avoid frustrating user experiences.

### SUMMARY

Various embodiments of the present disclosure provide user device and methods for facilitating an infinite navigation menu on a touch screen device.

In an embodiment, a method includes displaying, by a processor, a current page on a touch screen interface of a user device. The current page includes one or more expandable items and at least one collapsible item. Each of the one or more expandable items is associated with the at least one collapsible item. The method includes receiving, by the processor, a touch input at one of an expandable item of the one or more expandable items and a collapsible item of the at least one collapsible item. The method includes performing, by the processor, at least one of: if the touch input is received at the expandable item, displaying a next set of expandable items associated with the expandable item and if the touch input is received at the collapsible item, hiding a set of expandable items associated with the collapsible item from the current page.

In another embodiment, a user device includes a touch screen interface, at least one processor and a memory. The memory having stored therein machine executable instructions, that when executed by the at least one processor, cause the user device to display a current page on the touch screen interface of the user device. The current page includes one or more expandable items and at least one collapsible item. Each of the one or more expandable items is associated with the at least one collapsible item. The user device is further caused to receive a touch input at one of an expandable item of the one or more expandable items and a collapsible item of the at least one collapsible item. The user device is further caused to perform at least one of: if the touch input is received at the expandable item, display a next set of expandable items associated with the expandable item and if the touch input is received at the collapsible item, hide a set of expandable items associated with the collapsible item from the current page.

In one embodiment, the method includes displaying, by a processor, a current page on a touch screen interface of a user device. The current page includes one or more expandable items and one or more collapsible items. The method includes receiving, by the processor, a touch input at one of an expandable item of the one or more expandable items and a collapsible item of the one or more collapsible items. The method includes performing, by the processor, at least one of: displaying a next set of one or more expandable items on the current page, if the touch input is received at the expandable item and hiding the one or more expandable items from the current page, if the touch input is received at the collapsible item.

### BRIEF DESCRIPTION OF THE FIGURES

For a more complete understanding of example embodiments of the present technology, reference is now made to the following descriptions taken in connection with the accompanying drawings in which:

FIG. 1 shows a simplified representation of a UI displaying a user selection of an expandable item for activation of a hidden menu bar to be displayed on a user device, in accordance with an example embodiment of the present disclosure;

FIG. 2 shows a simplified representation of a UI displaying a menu bar upon activation, in accordance with an example embodiment of the present disclosure;

FIG. 3A shows a simplified representation of a UI displaying a user selection of an expandable item for initiating customization of the menu bar of FIG. 2, in accordance with an example embodiment of the present disclosure;

FIG. 3B shows a simplified representation of a UI displaying a plurality of selectable text-icons to be filtered for customization of the menu bar of FIG. 2, in accordance with an example embodiment of the present disclosure;

FIG. 4A shows a simplified representation of a UI displaying user selection of an expandable item from the menu bar of FIG. 2, in accordance with an example embodiment of the present disclosure;

FIG. 4B shows a simplified representation of a UI displaying a next set of expandable items corresponding to the user selection of the expandable item of FIG. 4A, in accordance with an example embodiment of the present disclosure;

FIG. 5 shows a simplified representation of a UI displaying another set of expandable items associated with user selection of an expandable item from the set of expandable items of FIG. 4B, in accordance with an example embodiment of the present disclosure;

FIG. 6 is a flow diagram of a method for facilitating menu navigation on a UI of a user device, in accordance with an example embodiment of the present disclosure;

FIG. 7 is another flow diagram of a method for facilitating menu navigation on a UI of a user device, in accordance with an example embodiment of the present disclosure; and

FIG. 8 shows a user device capable of implementing the various embodiments of the present disclosure.

The drawings referred to in this description are not to be understood as being drawn to scale except if specifically noted, and such drawings are only exemplary in nature.

### DETAILED DESCRIPTION

In the following description, for purposes of explanation, numerous specific details are set forth in order to provide a thorough understanding of the present disclosure. It will be apparent, however, to one skilled in the art that the present disclosure can be practiced without these specific details.

Reference in this specification to “one embodiment” or “an embodiment” means that a particular feature, structure, or characteristic described in connection with the embodiment is included in at least one embodiment of the present disclosure. The appearance of the phrase “in an embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not for other embodiments.

Moreover, although the following description contains many specifics for the purposes of illustration, anyone skilled in the art will appreciate that many variations and/or alterations to said details are within the scope of the present disclosure. Similarly, although many of the features of the present disclosure are described in terms of each other, or in conjunction with each other, one skilled in the art will appreciate that many of these features can be provided independently of other features. Accordingly, this description of the present disclosure is set forth without any loss of generality to, and without imposing limitations upon, the present disclosure.

The term “expandable item” used throughout the present disclosure refers to an icon or a text-icon capable of being selected by a touch input of a user on a touch screen interface of a user device. Each expandable item includes a next set of expandable items i.e. each icon or text-icon includes a next set of icons or text-icons capable of being selected through the touch input.

The term “collapsible item” used throughout the present disclosure refers to an icon or a text-icon capable of being selected by a touch input of a user on a touch screen interface of a user device to hide a set of expandable items associated with the collapsible item. Further, the term “collapsible item” used throughout the present disclosure refers to an icon or a text-icon capable of being selected for hiding already existing set of expandable items irrespective of the collapsible item being associated with the set of expandable items.

The term “touch input” used throughout the present disclosure refers to a touch input provided by a user using a finger-touch or a stylus-touch on a touch screen interface of a user device to select the expandable item and/or the collapsible item. The touch input includes a tap gesture, a swipe gesture in a predetermined direction, a scroll gesture in a predetermined direction, multi-touch gestures and the like.

Various embodiments disclosed herein provide methods and systems for facilitating an infinite navigation menu on a User Interface (UI) of a user device (e.g., a touch screen device). The systems are integrated in the user device to facilitate the infinite navigation menu on the UI. More specifically, a UI design is facilitated that helps alleviate the user experiences while navigating through an application or various functions of the user device. The user device includes a touch screen interface (hereinafter alternatively referred to as UI) using which the user can provide a touch input for navigating through menu options. In one embodiment, the user device is configured to display one or more expandable items on a current page of the application being browsed by the user. Some non-exhaustive examples of the expandable items include one or more options, one or more filters, one or more menu bars, one or more menu panels, a plurality of selectable icons, a plurality of selectable menu items, a plurality of selectable sub-menu items, a plurality of selectable text-icons and the like. Each expandable item can be represented as an icon or a text-icon and is associated with at least one collapsible item. The collapsible item can be represented as an icon or a text icon.

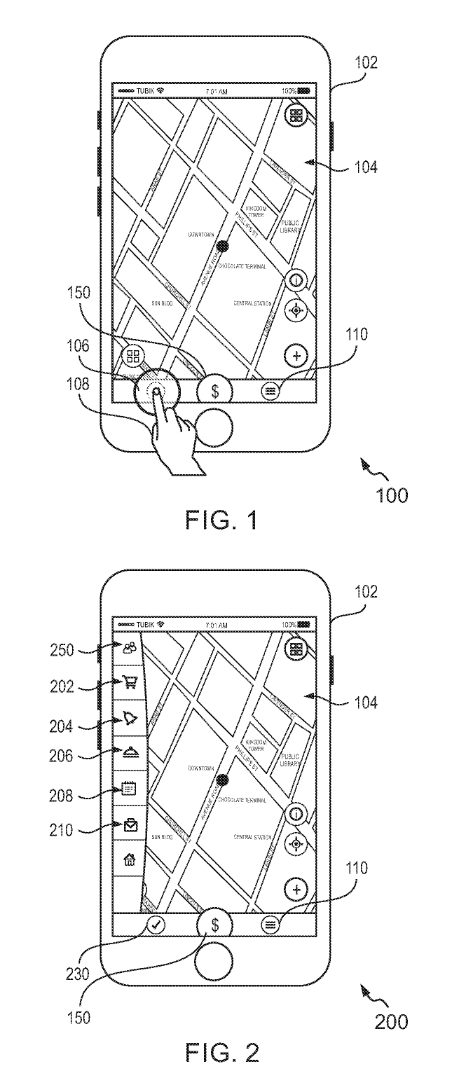

The user device is configured to receive the touch input on one of the expandable items or the collapsible item to perform one or more operations. For example, if the touch input is received at the expandable item, a next set of expandable items associated with the expandable item is displayed. Some non-exhaustive examples of a set of expandable items include one or more options, one or more filters, one or more menu bars, one or more menu panels, a plurality of selectable icons, a plurality of selectable menu items, a plurality of selectable sub-menu items, a plurality of selectable text-icons and the like. If the touch input is received at the collapsible item, a set of expandable items associated with the collapsible item from the current page are hidden. In another embodiment, the user device may be configured to hide a set of existing expandable items from the current page based on the touch input received at a collapsible item irrespective of being associated with any expandable item. Various UIs representing infinite navigation menu on a user device corresponding to various embodiments of the disclosure are explained in detail herein with reference to FIGS. 1 to 8.

FIG. 1 shows a simplified representation of a UI 100 displaying a user selection of an expandable item for activation of a hidden menu bar to be displayed on a user device, in accordance with an example embodiment of the present disclosure. A user device 102 (such as a smartphone, also hereinafter referred to as ‘smartphone 102’) with a touch screen interface is shown. An application 104 is running on the smartphone 102. The application 104 is exemplarily depicted as a GPS (Global Positioning System) map application, however it can be any application running on the smartphone 102. The application 104 includes one or more expandable items represented through one or more dedicated icons such as an icon 106 and an icon 110. The application further includes a collapsible item represented through an icon 150. In an example embodiment, the smartphone 102, upon receiving a touch input (e.g., a tap gesture (not shown)) from the user on the icon 150, may be configured to hide all the existing expandable items from the current page of the application 104. As can be seen, the icon 106, the icon 110 and the icon 150 are represented by very small size at the bottom of a current page of the application 104 and therefore do not occupy much screen space. This enhances user experience of menu navigation compared to fixed and permanently present menu bars anchored at the top of the screen, that are difficult to access with one hand. Further, depending on the screen size of the user device (such as a tablet), it becomes difficult for the user to access various menu items present in hard to reach areas of the user device. Such navigation inefficiencies are overcome by the menu placement configuration shown on the UI 100.

The icon 106 is shown selected by the user (not shown) through a touch input 108 such as a tap gesture 108. In one embodiment, the smartphone 102, upon receiving user selection of the icon 106, is configured to display a set of other expandable items (which are off screen before activation) associated with the icon 106. Similarly, if the user selects the icon 110, the smartphone 102 may be configured to display another set of expandable items associated with the icon 110. It is noted that the application 104 is included in the disclosure only for explaining various features of the UI design. The various features of the UI design may equally be applicable on the user device for navigating through one or more functions of the user device. In one example embodiment, the smartphone 102 is configured to display a menu bar upon receiving the tap gesture 108 from the user. This is explained in detail with reference to FIG. 2.

FIG. 2 shows a simplified representation of a UI 200 displaying a menu bar 250 upon activation, in accordance with an example embodiment of the present disclosure. As shown, the menu bar 250 is displayed as a vertical bar at the left side (on the current page of) the application 104 of the smartphone 102. However, in alternate embodiments, the menu bar 250 may be anchored to the top-right side of the current page 104, or to any other part of the display screen of the smartphone 102 without deviating from the scope of the disclosure. Existing UI designs generally provide hamburger menus (e.g., icon 106 of FIG. 1) as a permanent placeholder to access a menu located on a different page or screen. Therefore, in order to access the additional menu items associated with the hamburger menu, a user needs to navigate away from the current page 104 and onto a new page. This impacts the user experience by forcing user to toggle between multiple pages and/or screens. In contrast, various features of current UI design provide the user with a facility to access a list of menu items i.e. the set of other expandable items associated with the icon 106 while still remaining immersed on the content on the current page 104. An example of this is shown on the UI 200 by the menu bar 250 displaying a plurality of expandable items on the current page 104 of the smartphone 102.

In one embodiment, the menu bar 250 is depicted to include a plurality of selectable icons 202, 204, 206, 208 and 210 for user selection. The plurality of selectable icons 202-210 are displayed without their associated text labels which further assist in freeing the valuable screen space of the smartphone 102. As explained with reference to FIG. 1, the menu bar 250 is kept hidden before being activated by the tap gesture 108 of the user. In an example embodiment, the menu bar 250 may be configured to hide itself from the display if it does not receive a user input for a predetermined time-period. The auto-hide feature may be provided to keep the content of the application 104 always completely visible to the user. In such scenarios, the user may be enabled to select a check mark icon 230 as displayed at the bottom of the application 104 to keep the menu bar 250 from hiding itself off the screen. In another example embodiment, the icon 106 of FIG. 1, may be depicted as an expandable item and a collapsible item at the same time. For example, a tap gesture on the icon 106 may hide the menu bar 250 if it is already displayed on the screen. In yet another example embodiment, the menu bar 250 may be hidden from the display by providing a touch input at the icon 150. The feature of hiding or revealing the menu bar 250 at the user's behest offers more screen real estate to the user.

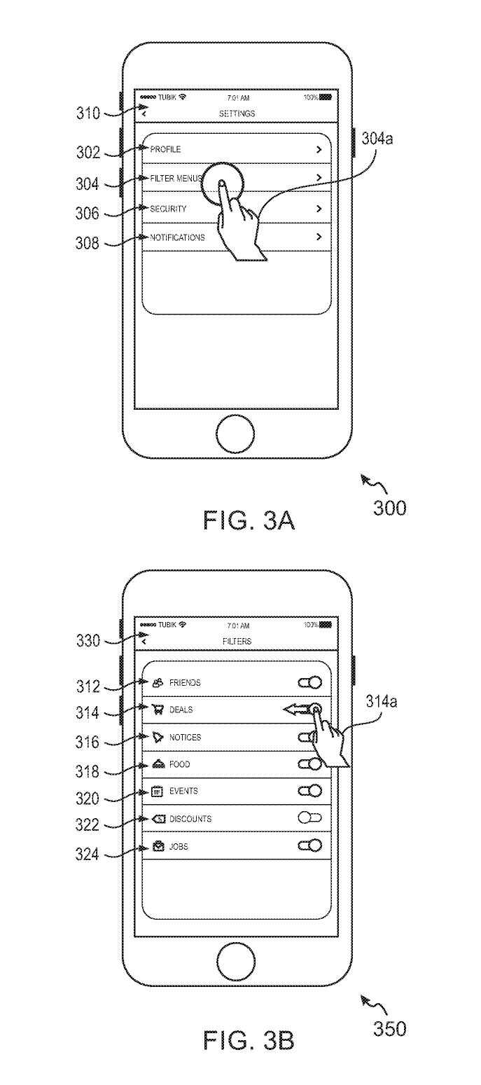

In one example embodiment, the menu bar 250 is vertically scrollable to display additional icons, thereby enabling the menu bar 250 to include unlimited number of icons. The menu bar 250 is also customizable based one or more user preferences. The user may be enabled to select one or more selectable icons of his/her choice from the list of icons to customize the menu bar 250. For example, there may be a few icons which the user has been using frequently; he/she would want them to be displayed as one touch navigation shortcuts on the menu bar 250 to save time in menu navigation. The customization of the menu bar 250 can be facilitated by the smartphone 102 upon receiving a touch input on the icon 110. The corresponding UIs for filtering the one or more selectable icons to be present on the menu bar 250 are shown and explained with reference to FIGS. 3A and 3B.

FIG. 3A shows a simplified representation of a UI 300 displaying a user selection of an expandable item for initiating customization of the menu bar 250 of FIG. 2, in accordance with an example embodiment of the present disclosure. The UI 300 is displayed on the smartphone 102 based on the touch input received at the icon 110. The UI 300 is depicted to include a header 310 displaying text ‘Settings’. Under ‘Settings’ are shown one or more options 302, 304, 306 and 308 for user selection. The one or more options 302-308 are depicted on the UI 300 with their associated text labels. For example, option 302 corresponds to profile, option 304 corresponds to filter menus, option 306 corresponds to security and the option 308 corresponds to notifications. It is noted that each option acts as an expandable item configured to receive a touch input from the user and thereby displays associated set of other expandable items.

A tap gesture 304a is shown on the option 304 (see, filter menus). As shown, the one or more options 302-308 under the header 310 (i.e. Settings) may be displayed on a new page of the application 104 for initiating customization of the menu bar 250. The tap gesture 304a on the option 304 navigates the user to another next page i.e. a UI 350 of FIG. 3B for customizing the menu bar 250 by selecting one or more icons of his/her choice. In one embodiment, the header 310 may act as a collapsible item. For example, the user may be enabled to provide a touch input on the header 310 at any time during the menu navigation, to go back to the previous page (i.e. UI 200) and to exit the customization of the menu bar 250.

FIG. 3B shows a simplified representation of a UI 350 displaying a plurality of selectable text-icons to be filtered for customization of the menu bar of FIG. 2, in accordance with an example embodiment of the present disclosure. A header 330 displaying text ‘Filters’ on the UI 350 is depicted to include the plurality of selectable text-icons 312, 314, 316, 318, 320, 322 and 324. The icons 202-210 as shown on the menu bar 250 of the UI 200 are depicted on the UI 350 with their associated text labels i.e. as text-icons. For example, the icon 202 corresponds to deals (see, text-icon 314), icon 204 corresponds to notices (see, text-icon 316), icon 206 corresponds to food (see, text-icon 318), icon 208 corresponds to events (see, text-icon 320) and icon 210 corresponds to jobs (see, text-icon 324).

Further, the text-icons 312-324 are displayed along with their status of being selected (or turned on) or deselected (or turned off) for filtering the menu bar 250. The text icons 312, 316, 318, 320 and 324 are shown as selected/turned on to be present/added on the menu bar 250. The text icon 322 is shown not selected/turned off from being added on the menu bar 250. Further, the text icon 314 is shown being deselected (by an arrow in a predetermined direction) by the user through a touch input 314a for customizing the menu bar 250. In an example embodiment, the header 330 is capable of receiving a touch input from the user and thereby acting as a collapsible item to facilitate display of the previous page (i.e. UI 300) to exit the customization of the menu bar 250 by hiding the text icons 312-324.

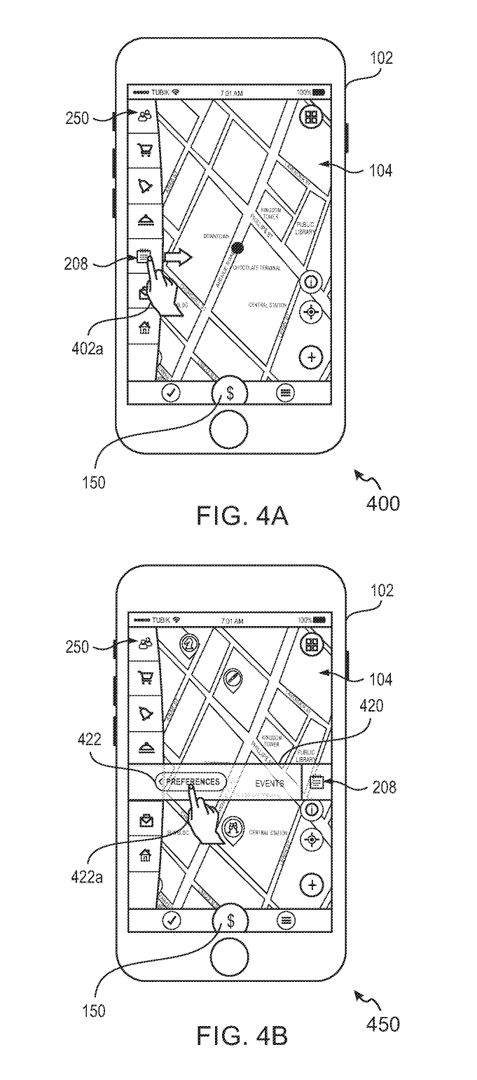

In one embodiment, the user may select an icon from among the icons 202-210 present on the menu bar 250 of the UI 200 post customization of the menu bar 250. In such scenarios, the smartphone 102 may be configured to display a next set of expandable items associated with the user selection of an icon from the menu bar 250. Such a UI is explained with reference to FIG. 4A.

FIG. 4A shows a simplified representation of a UI 400 displaying user selection of an expandable item (i.e. an icon) from the menu bar of FIG. 2, in accordance with an example embodiment of the present disclosure. As shown, the user has selected the icon 208 using a swipe gesture 402a (e.g., shown by arrow from left to right direction) from the menu bar 250. The standard gesture-enabled menu bar interface uses gesture-based commands such as, but not limited to, a left or right swiping motion or a pull-down gesture to enable activation of the menu bar based on the gesture used. Currently, such gesture enabled interface does not allow the user to delineate intent of the gesture. For example, if a user wants to access the menu bar in existing application utilizing the gesture-enabled menu bar interface, he/she may provide a swipe gesture such as the swipe gesture 402a to activate the menu bar. However, this may simultaneously navigate the user to a new page of the application by failing to interpret and execute a menu access command. The UI design of the present disclosure overcomes this limitation.

The smartphone 102 is configured to receive the swipe gesture 402a and display a plurality of menu items associated with the icon 208 for user selection. FIG. 4B shows a simplified representation of a UI 450 displaying a next set of expandable items (i.e. a plurality of menu items) corresponding to the user selection of the icon 208, in accordance with an example embodiment of the present disclosure.

A horizontal menu bar 420 is shown swiped out on the current page of the application 104 associated with the swipe gesture 402a received at the icon 208. The configured placement of the menu bar 420 as shown on the UI 450 is in such a way that the original content of the application 104 is least obstructed from the user's view. The menu bar 420 includes icon 208 with its associated text label ‘Events’ and a menu item 422 displaying text ‘Preferences’. Although only one menu item is shown on the UI 450, it should be noted that various embodiments may include a plurality of menu items for user selection. The menu bar 420 may be horizontally scrollable to accommodate and display the additional menu items, thereby enabling the menu bar 420 to offer infinite menu items to the user for user selection. In various embodiment, the menu bar 420 may only include one or more icons without their associated text labels in order to occupy least amount of screen space of the smartphone 102.

In one example embodiment, the user may be enabled to provide a swipe gesture in reverse direction (e.g., in right to left direction) on the icon 208 to hide the menu bar 420 from the display. In another example embodiment, the user may provide a touch input on the icon 150 of the UI 450 to hide the menu bar 420 and the menu bar 250 from the display. It should be noted such a feature of hiding the menu bar 450 and the menu bar 250 as per user's will, offers a huge amount of screen real estate to the user. A tap gesture 422a is shown on the menu item 422 from the user for selecting the ‘Preferences’ associated with ‘Events’. The smartphone 102 is configured to receive the tap gesture 422a and display a plurality of sub-menu items associated with the menu item 422.

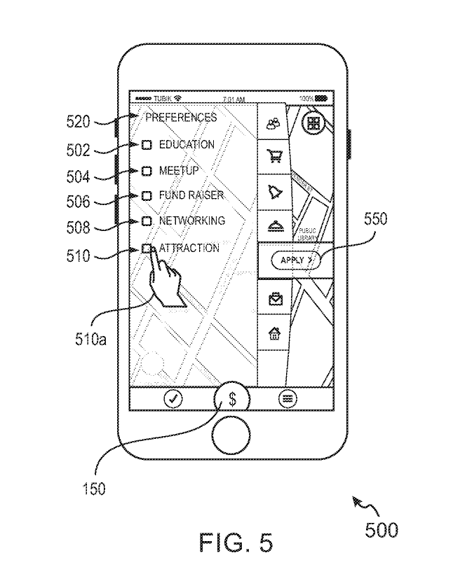

FIG. 5 shows a simplified representation of a UI 500 displaying another set of expandable items (i.e. a plurality of sub-menu items) associated with user selection of an expandable item (i.e. the menu item 422) from the set of expandable items of FIG. 4B, in accordance with an example embodiment of the present disclosure. The UI 500 includes a header 520 displaying text ‘Preferences’. Under the header 520 are displayed a plurality of sub-menu items 502, 504, 506, 508 and 510 with corresponding text labels education, meetup, fund raiser, networking and attraction respectively. Each sub-menu item is associated with a check box for enabling the user of multiple selection of sub-menu items. In one embodiment, each sub-menu item acts as an expandable item and/or a collapsible item. Further, the header 520 is capable of receiving a touch input from the user in order to hide the sub-menu items 502-510 from the display. Alternatively, the user may provide a touch input on the icon 150 of the UI 500 to hide all the existing set of expandable items present on the current page of the application 104. In various embodiments, the smartphone 102 may be configured to receive multiple touch inputs on the icon 150 in a sequential manner. This may enable the user to hide a set of existing expandable items sequentially from the display based on every touch input provided on the icon 150, thereby freeing the screen space of the display screen. For example, the smartphone 102 may hide the menu bar 250 from the display based on a first touch input on the icon 150 on the UI 500 and further hide the sub-menu items 502-510 from the display based on the second touch input on the icon 150.

A tap gesture 510a is shown on the sub-menu item 510. Upon selection of desired sub-menu items using the associated check boxes, the user may provide a touch input (not shown) at a button 550 displaying text ‘Apply’ to submit the selection. The plurality of sub-menu items 502-510 may be vertically scrollable to accommodate and display additional sub-menu items, thereby enabling an infinite menu accommodation feature for user selection. Some non-exhaustive examples of the additional sub-menu items include exhibition, product launch, concerts, party places and the like. In one embodiment, the smartphone 102, upon receiving the user selection of ‘Preferences’ for the ‘Events’, may be configured to display content information associated with the selected sub-menu items. For example, the smartphone 102 may display one or more tourist places based on user selection of the sub-menu item 510 (see, attraction). In other embodiments, the smartphone 102 may set the preferences as filters and display corresponding filtered information on the application 104 by modifying the existing content of the application 104.

The plurality of expandable items and the collapsible items associated with each expandable item explained so far with reference to UIs 200, 300, 350, 400, 450 and 500 are depicted herein for illustration purposes and the present disclosure is not limited to these expandable items and collapsible items. The UIs may include more or fewer menu bars, options, filters, selectable icons, menu items, sub-menu items etc. and in different configurations. Moreover, in some embodiments, one or more expandable items may include drop-down menus or may be associated with radio buttons to enable user selection of options. Further, the swipe and scroll gestures of the disclosure are touch sensitive and use geospatial references to determine the desired scroll destination. The farther the user swipes in either direction on a menu bar, the more he/she can scroll through the menu bar in that particular direction to access the corresponding menu items.

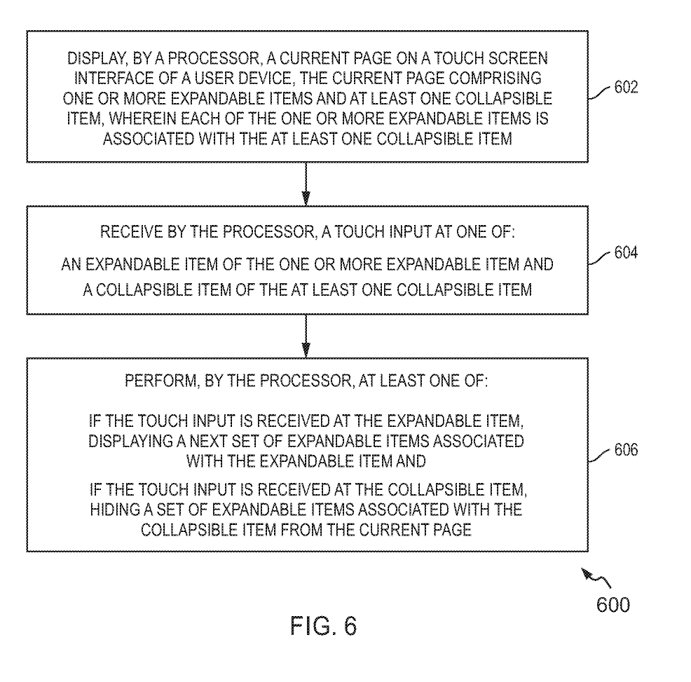

FIG. 6 is a flow diagram of a method 600 for facilitating menu navigation on a UI of a user device, in accordance with an example embodiment of the present disclosure. The various steps and/or operations of the flow diagram, and combinations of steps/operations in the flow diagram, may be implemented by, for example, hardware, firmware, a processor, circuitry and/or by the user device 102 of FIG. 1 and/or by a different electronic device associated with the execution of software that includes one or more computer program instructions.

At 602, a current page on a touch screen interface of a user device is displayed by a processor. The current page includes one or more expandable items and at least one collapsible item. Each of the one or more expandable items is associated with the at least one collapsible item. The processor may be a component of a user device such as the smartphone 102 of FIG. 1. The user device may include a touch screen interface on which one or more expandable items and associated collapsible items may be displayed.

At 604, a touch input at one of an expandable item of the one or more expandable items and a collapsible item of the at least one collapsible item is received by the processor. Some non-exhaustive examples of touch input include a tap gesture, a swipe gesture in a predetermined direction, a scroll gesture in a predetermined direction and the like. For example, a swipe gesture on the touch screen interface of the user device such as the smartphone 102 from left to right direction may display a hidden menu bar and accordingly another swipe gesture on the same menu bar in the direction from right to left may hide the menu bar from the screen as explained with reference to FIGS. 4A and 4B.

At 606, at least one operation is performed by the processor. If the touch input is received at the expandable item, a next set of expandable items associated with the expandable item is displayed. If the touch input is received at the collapsible item, a set of expandable items associated with the collapsible item is hidden from the current page.

It should be noted that a sequence of expandable items and a set of collapsible items can be designed in a multi-tiered fashion i.e. in several layers. For example, if one expandable item is selected, it will present a next set of expandable items. Further, when one expandable item from the next set of expandable items is selected, it will again present another next set of expandable items, and so on. Similarly, several layers of collapsible items can also be designed to make the design highly scalable.

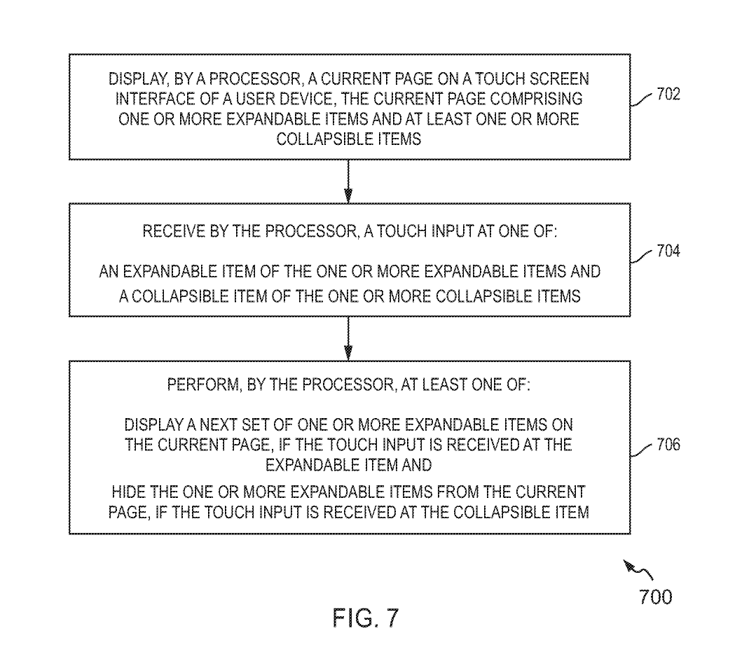

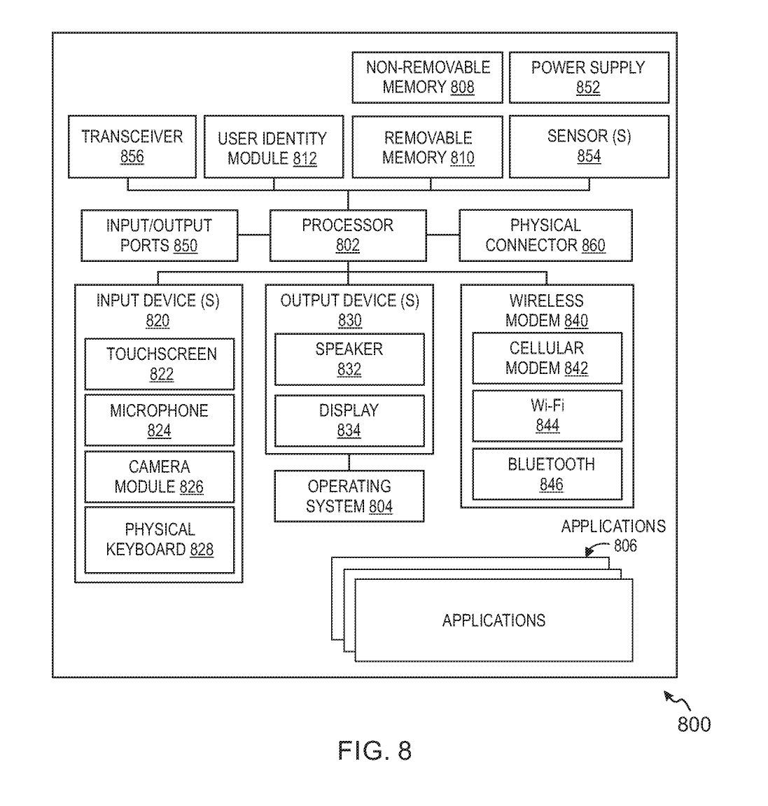

FIG. 7 is another flow diagram of a method 700 for facilitating menu navigation on a UI of a user device, in accordance with an example embodiment of the present disclosure. The various steps and/or operations of the flow diagram, and combinations of steps/operations in the flow diagram, may be implemented by, for example, hardware, firmware, a processor, circuitry and/or by the user device 102 of FIG. 1 and/or by a different electronic device associated with the execution of software that includes one or more computer program instructions.

At 702, a current page on a touch screen interface of a user device is displayed by a processor. The current page includes one or more expandable items and one or more collapsible items. The processor may be a component of a user device, such as the smartphone 102 of FIG. 1.

At 704, a touch input at one of an expandable item of the one or more expandable items and a collapsible item of the one or more collapsible items is received by the processor.

At 706, at least one operation is performed by the processor. A next set of one or more expandable items on the current page are displayed, if the touch input is received at the expandable item. The one or more expandable items from the current page are hidden, if the touch input is received at the collapsible item.

The disclosed methods 600 and 700 or one or more operations of the methods 600 and 700 may be implemented using software including computer-executable instructions stored on one or more computer-readable media (e.g., non-transitory computer-readable media, such as one or more optical media discs, volatile memory components (e.g., DRAM or SRAM), or nonvolatile memory or storage components (e.g., hard drives or solid-state nonvolatile memory components, such as Flash memory components) and executed on a computer (e.g., any suitable computer, such as a laptop computer, net book, Web book, tablet computing device, smart phone, or other mobile computing device). Such software may be executed, for example, on a single local computer or in a network environment (e.g., via the Internet, a wide-area network, a local-area network, a remote web-based server, a client-server network (such as a cloud computing network), or other such network) using one or more network computers. Additionally, any of the intermediate or final data created and used during implementation of the disclosed methods or systems may also be stored on one or more computer-readable media (e.g., non-transitory computer-readable media) and are considered to be within the scope of the disclosed technology. Furthermore, any of the software-based embodiments may be uploaded, downloaded, or remotely accessed through a suitable communication means. Such suitable communication means include, for example, the Internet, the World Wide Web, an intranet, software applications, cable (including fiber optic cable), magnetic communications, electromagnetic communications (including RF, microwave, and infrared communications), electronic communications, or other such communication means.

FIG. 8 shows a user device 800 capable of implementing the various embodiments of the present disclosure. The user device 800 may correspond to the user device 102/the smartphone 102 of FIG. 1. The user device 800 is depicted to include one or more applications 806 (such as the application 104). The user device 800 as illustrated and hereinafter described is merely illustrative of one type of device and should not be taken to limit the scope of the embodiments. Further, some of the components described below in connection with that the user device 800 may be optional and thus in an example embodiment may include more, less or different components than those described in connection with the example embodiment of the FIG. 8. As such, among other examples, that the user device 800 could be any of a mobile electronic device, for example, cellular phones, tablet computers, laptops, mobile computers, desktop computers, personal digital assistants (PDAs), mobile televisions, mobile digital assistants, or any combination of the aforementioned, and other types of communication or multimedia devices with touch screen interface.

The illustrated user device 800 includes a controller or a processor 802 for performing such tasks as signal coding, data processing, image processing, input/output processing, power control, and/or other functions. In an embodiment, the processor 802 may be embodied as one or more of various processing devices, such as a coprocessor, a microprocessor, a controller, a digital signal processor (DSP), processing circuitry with or without an accompanying DSP, or various other processing devices including integrated circuits such as, for example, an application specific integrated circuit (ASIC), a field programmable gate array (FPGA), a microcontroller unit (MCU), a hardware accelerator, a special-purpose computer chip, or the like. The processor 802 is capable of executing the stored machine executable instructions in the memory (e.g., non-removable memory 808 or removable memory 810) or within the processor 802 or any storage location accessible to the processor 802.

The processor 802 is configured to perform the various operations as explained with reference to methods 600 and 700. For example, the processor 802 is configured to display a current page on the touch screen interface (such as the UIs 200, 300, 350, 400, 450 and 500) of the user device 800 including one or more expandable items and at least one collapsible item associated with each of the one or more expandable items. Further, if a touch input is received at an expandable item, the processor 802 is configured to display a next set of expandable items associated with the expandable item. Alternatively, if a touch input is received at a collapsible item, the processor 802 is configured to hide a set of expandable items associated with the collapsible item from the current page. In other embodiments, the processor 802 is configured to hide the one or more expandable items present on the current page based on the touch input received at a collapsible item.

The user device 800 includes an operating system 804 that controls the allocation and usage of the components of the user device 800 and support for one or more applications programs (see, applications 806). The applications 806 may include common mobile computing applications (e.g., telephony applications, email applications, calendars, contact managers, web browsers, messaging applications) or any other computing application such as the GPS map application 104.

The illustrated user device 800 includes one or more memory components, for example, a non-removable memory 808 and/or removable memory 810. The non-removable memory 808 can include RAM, ROM, flash memory, a hard disk, or other well-known memory storage technologies. The removable memory 810 can include flash memory, smart cards, or a Subscriber Identity Module (SIM). The one or more memory components can be used for storing data and/or code for running the operating system 804 and the applications 806. The one or more memory components can be used for storing data and/or code for running the operating system 804 and the applications 806. The user device 800 may further include a user identity module (UIM) 812. The UIM 812 may be a memory device having a processor built in. The UIM 812 may include, for example, a subscriber identity module (SIM), a universal integrated circuit card (UICC), a universal subscriber identity module (USIM), a removable user identity module (R-UIM), or any other smart card. The UIM 812 typically stores information elements related to a mobile subscriber. The UIM 812 in form of the SIM card is well known in Global System for Mobile Communications (GSM) communication systems, Code Division Multiple Access (CDMA) systems, or with third-generation (3G) wireless communication protocols such as Universal Mobile Telecommunications System (UMTS), CDMA9000, wideband CDMA (WCDMA) and time division-synchronous CDMA (TD-SCDMA), or with fourth-generation (4G) wireless communication protocols such as LTE (Long-Term Evolution).

The user device 800 can support one or more input devices 820 and one or more output devices 830. Examples of the input devices 820 may include, but are not limited to, a touch screen 822 (e.g., capable of capturing finger tap inputs, finger gesture inputs, multi-finger tap inputs, multi-finger gesture inputs, or keystroke inputs from a virtual keyboard or keypad), a microphone 824 (e.g., capable of capturing voice input), a camera module 826 (e.g., capable of capturing still picture images and/or video images) and a physical keyboard 828. Examples of the output devices 830 may include, but are not limited to a speaker 832 and a display 834. Other possible output devices (not shown in the FIG. 8) can include piezoelectric or other haptic output devices. Some devices can serve more than one input/output function. For example, the touchscreen 822 and the display 834 can be combined into a single input/output device.

A wireless modem 840 can be coupled to one or more antennas (not shown in the FIG. 8) and can support two-way communications between the processor 802 and external devices, as is well understood in the art. The wireless modem 840 is shown generically and can include, for example, a cellular modem 842 for communicating at long range with the mobile communication network, a Wi-Fi compatible modem 844 for communicating at short range with an external Bluetooth-equipped device or a local wireless data network or router, and/or a Bluetooth-compatible modem 846. The wireless modem 840 is typically configured for communication with one or more cellular networks, such as a GSM network for data and voice communications within a single cellular network, between cellular networks, or between the user device 800 and a public switched telephone network (PSTN).

The user device 800 can further include one or more input/output ports 850, a power supply 852, one or more sensors 854 for example, an accelerometer, a gyroscope, a compass, or an infrared proximity sensor for detecting the orientation or motion of the user device 800, a transceiver 856 (for wirelessly transmitting analog or digital signals) and/or a physical connector 860, which can be a USB port, IEEE 1294 (FireWire) port, and/or RS-232 port. The illustrated components are not required or all-inclusive, as any of the components shown can be deleted and other components can be added.

Various example embodiments offer, among other benefits, techniques for infinite menu navigation on UI of the user device and simultaneously hiding or revealing the infinite menu options at the user's commands by offering the user with maximum screen real estate. The methods and devices disclosed herein facilitate User Interface design that also hides preselected menu items and icons out of sight until revealed and activated. Various embodiments allow for customization of menus. Various embodiments facilitate unlimited menus, sub-menus, filters and preferences. As the menus are hideable, visibility of the existing content on the display screen of the user device does not get obstructed. Further, all the gesture based commands (e.g., tap, scroll, swipe left, swipe right etc.) described in the disclosure are executable from anywhere on the touch-screen. The user is no longer be compelled to reach for unnaturally far corners of the touch-screen in order to access a menu, and thereby can seamlessly navigate using one hand.

Although the disclosure has been described with reference to specific exemplary embodiments, it is noted that various modifications and changes may be made to these embodiments without departing from the broad spirit and scope of the disclosure. For example, the various operations, blocks, etc., described herein may be enabled and operated using hardware circuitry (for example, complementary metal oxide semiconductor (CMOS) based logic circuitry), firmware, software and/or any combination of hardware, firmware, and/or software (for example, embodied in a machine-readable medium). For example, the systems and methods may be embodied using transistors, logic gates, and electrical circuits (for example, application specific integrated circuit (ASIC) circuitry and/or in Digital Signal Processor (DSP) circuitry).

Particularly, the user device 800 and its various components may be enabled using software and/or using transistors, logic gates, and electrical circuits (for example, integrated circuit circuitry such as ASIC circuitry). Various embodiments of the disclosure may include one or more computer programs stored or otherwise embodied on a computer-readable medium, wherein the computer programs are configured to cause a processor or computer to perform one or more operations (for example, operations explained herein with reference to FIGS. 6 and 7). A computer-readable medium storing, embodying, or encoded with a computer program, or similar language, may be embodied as a tangible data storage device storing one or more software programs that are configured to cause a processor or computer to perform one or more operations. Such operations may be, for example, any of the steps or operations described herein. In some embodiments, the computer programs may be stored and provided to a computer using any type of non-transitory computer readable media. Non-transitory computer readable media include any type of tangible storage media. Examples of non-transitory computer readable media include magnetic storage media (such as floppy disks, magnetic tapes, hard disk drives, etc.), optical magnetic storage media (e.g., magneto-optical disks), CD-ROM (compact disc read only memory), CD-R (compact disc recordable), CD-R/W (compact disc rewritable), DVD (Digital Versatile Disc), BD (BLU-RAY® Disc), and semiconductor memories (such as mask ROM, PROM (programmable ROM), EPROM (erasable PROM), flash memory, RAM (random access memory), etc.). Additionally, a tangible data storage device may be embodied as one or more volatile memory devices, one or more non-volatile memory devices, and/or a combination of one or more volatile memory devices and non-volatile memory devices. In some embodiments, the computer programs may be provided to a computer using any type of transitory computer readable media. Examples of transitory computer readable media include electric signals, optical signals, and electromagnetic waves. Transitory computer readable media can provide the program to a computer via a wired communication line (e.g., electric wires, and optical fibers) or a wireless communication line.

Various embodiments of the disclosure, as discussed above, may be practiced with steps and/or operations in a different order, and/or with hardware elements in configurations, which are different than those which, are disclosed. Therefore, although the disclosure has been described based upon these exemplary embodiments, it is noted that certain modifications, variations, and alternative constructions may be apparent and well within the spirit and scope of the disclosure.

Although various exemplary embodiments of the disclosure are described herein in a language specific to structural features and/or methodological acts, the subject matter defined in the appended claims is not necessarily limited to the specific features or acts described above. Rather, the specific features and acts described above are disclosed as exemplary forms of implementing the claims.

What is claimed is:

1. A computer-implemented method, comprising:
displaying, by a processor, a current page on a touch screen interface of a user device, the current page comprising one or more expandable items and at least one collapsible item, wherein each of the one or more expandable items is associated with the at least one collapsible item;
receiving, by the processor, a touch input at one of:
an expandable item of the one or more expandable items; and
a collapsible item of the at least one collapsible item; and
performing, by the processor, at least one of:
if the touch input is received at the expandable item, displaying a next set of expandable items associated with the expandable item; and
if the touch input is received at the collapsible item, hiding a set of expandable items associated with the collapsible item from the current page.

2. The method as claimed in claim 1, wherein displaying the next set of expandable items associated with the expandable item comprises:
displaying a menu bar comprising of a plurality of selectable icons, wherein the menu bar is displayed corresponding to the touch input received at the expandable item, and wherein the menu bar is associated with a collapsible item of the at least one collapsible item.

3. The method as claimed in claim 2, further comprising:
hiding the menu bar corresponding to a touch input received at the collapsible item associated with the menu bar.

4. The method as claimed in claim 2, wherein the plurality of selectable icons of the menu bar are customizable based on one or more user preferences.

5. The method as claimed in claim 2, further comprising:
displaying a plurality of selectable menu items corresponding to a touch input received at an icon of the plurality of selectable icons, wherein each selectable icon of the plurality of selectable icons is associated with a collapsible item of the at least one collapsible item.

6. The method as claimed in claim 5, further comprising:
hiding the plurality of selectable menu items corresponding to a touch input received at a collapsible item associated with a selected icon.

7. The method as claimed in claim 5, further comprising:
displaying a plurality of selectable sub-menu items corresponding to a touch input received at a menu item of the plurality of selectable menu items, wherein each selectable menu item of the plurality of selectable menu items is associated with a collapsible item of the at least one collapsible item.

8. The method as claimed in claim 7, further comprising:
hiding the plurality of selectable sub-menu items corresponding to a touch input received at a collapsible item associated with a selected menu item.

9. The method as claimed in claim 7, further comprising:
receiving a touch input on a sub-menu item of the plurality of selectable sub-menu items; and
displaying a content information associated with the selected sub-menu item.

10. The method as claimed in claim 1, wherein the touch input is at least one of:
a tap gesture, a swipe gesture in a predetermined direction, a scroll gesture in a predetermined direction and a multi-touch gesture.

11. A user device, comprising:
a touch screen interface;
at least one processor; and
a memory having stored therein machine executable instructions, that when executed by the at least one processor, cause the user device to:
display a current page on the touch screen interface of the user device, the current page comprising one or more expandable items and at least one collapsible item, wherein each of the one or more expandable items is associated with the at least one collapsible item;
receive a touch input at one of:
an expandable item of the one or more expandable items; and
a collapsible item of the at least one collapsible item; and
perform at least one of:
if the touch input is received at the expandable item, display a next set of expandable items associated with the expandable item; and
if the touch input is received at the collapsible item, hide a set of expandable items associated with the collapsible item from the current page.

12. The user device as claimed in claim 11, wherein for displaying the next set of expandable items associated with the expandable item, the user device is caused to:
display a menu bar comprising of a plurality of selectable icons, wherein the menu bar is displayed corresponding to the touch input received at the expandable item, and wherein the menu penal is associated with a collapsible item of the at least one collapsible item.

13. The user device as claimed in claim 12, wherein the user device is further caused to:
hide the menu bar corresponding to a touch input received at the collapsible item associated with the menu bar.

14. The user device as claimed in claim 12, wherein the plurality of selectable icons of the menu bar are customizable based on one or more user preferences.

15. The user device as claimed in claim 12, wherein the user device is further caused to:
display plurality of selectable menu items corresponding to a touch input received at an icon of the plurality of selectable icons, wherein each selectable icon of the plurality of selectable icons is associated with a collapsible item of the at least one collapsible item.

16. The user device as claimed in claim 15, wherein the user device is further caused to:
hide the plurality of selectable menu items corresponding to a touch input received at a collapsible item associated with a selected icon.

17. The user device as claimed in claim 15, wherein the user device is further caused to:
display a plurality of selectable sub-menu items corresponding to a touch input received at a menu item of the plurality of selectable menu items, wherein each selectable menu item of the plurality of selectable menu items is associated with a collapsible item of the at least one collapsible item.

18. The user device as claimed in claim 17, wherein the user device is further caused to:
hide the plurality of selectable sub-menu items corresponding to a touch input received at a collapsible item associated with a selected menu item.

19. The user device as claimed in claim 17, wherein the user device is further caused to:
receive a touch input on a sub-menu item of the plurality of selectable sub-menu items; and
display a content information associated with the selected sub-menu item.

20. A computer-implemented method, comprising:
displaying, by a processor, a current page on a touch screen interface of a user device, the current page comprising one or more expandable items and one or more collapsible items;
receiving, by the processor, a touch input at one of:
an expandable item of the one or more expandable items; and
a collapsible item of the one or more collapsible items; and
performing, by the processor, at least one of:
displaying a next set of one or more expandable items on the current page, if the touch input is received at the expandable item; and
hiding the one or more expandable items from the current page, if the touch input is received at the collapsible item.
